(19) United States
(12) Patent Application Publication
(10) Pub. No.: US 2011/0239992 A1
(43) Pub. Date: Oct. 6, 2011

(54) Engine Control System For An Aircraft Diesel Engine

(75) Inventor: Bodo Metzdorf, Hamburg (DE)

(73) Assignee: THIELERT AIRCRAFT ENGINES GMBH, Lichtenstein (DE)

(21) Appl. No.: 13/133,421

(22) PCT Filed: Aug. 6, 2009
(86) PCT No.: PCT/EP09/60236

§ 371 Date: Jun. 21, 2011

(30) Foreign Application Priority Data
Dec. 12, 2008 (DE) 10 2008 054 589.9

(51) Int. Cl. F02M 51/00

(52) U.S. Cl. 123/488

(57) ABSTRACT

In an engine control system for an aircraft diesel engine for a propeller aircraft for controlling the injection valves, charge pressure valves, common rail pressure valves and propeller control valves actuated by non-redundant actuators, comprising a plurality of sensors and a regulating device connected thereto and to the actuators, two engine control units—first and second—which are each connected to a first and a second power supply and are each connected to the sensors, are provided and are interconnected by way of a serial bus and can be connected selectively to the actuators by way of relays that are supplied with power together with the first engine control unit. The two engine control units each have a diagnostic function for calculating the respective health levels (A and B), which are determined by the defects detected, can be exchanged by way of the serial bus and are compared to one another. If the health level (A) of the first engine control unit is below the health level (B) of the second engine control unit, the power supply to the relay is interrupted, so that the second engine control unit is automatically connected to the actuators by way of the relays that have released, and consequently a redundant engine control system for an aircraft diesel engine is created. The core of the invention is the automatically switchable connection of the two engine control units communicating with one another via relays depending on the calculated health level.

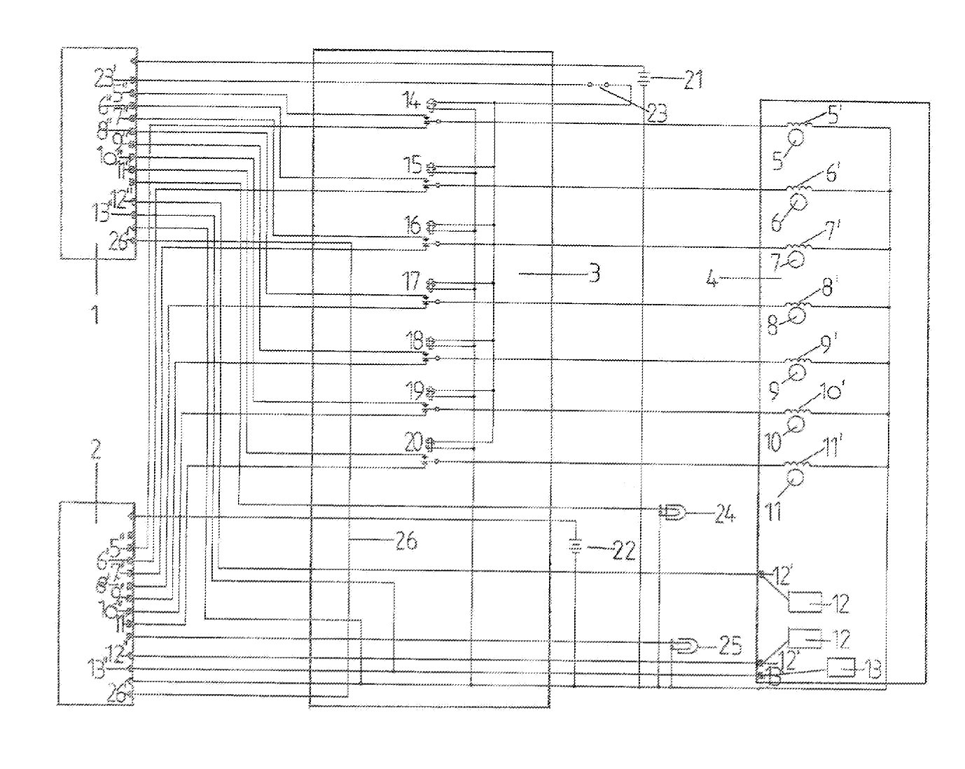

### TECHNICAL FIELD

The invention concerns an engine control system for an aircraft diesel engine for propeller-driven aircraft for purposes of controlling injection valves, charge pressure control valves, common rail pressure control valves and propeller control valves actuated by actuators, which system comprises a plurality of sensors and a regulating device connected to the latter and to the actuators.

Background

It is of known art to deploy motor vehicle diesel engines operated with an aviation fuel (kerosene) for the purpose of driving propeller-driven aircraft. Such aircraft diesel engines are operated with turbochargers to achieve a specified charge pressure and also with common rail injection, and are fitted accordingly with injection valves and also charge pressure control valves, rail pressure control valves and propeller control valves, which are actuated by actuators assigned to the valves. Control of the actuators of non-redundant design takes place by means of an engine controller on the basis of sensor signals generated by the sensors. In the event of a malfunction in the engine controller, however, reliable functioning of the diesel engine is no longer guaranteed, and in fact when it is deployed as an aircraft diesel engine the consequences are unacceptable.

### SUMMARY OF THE INVENTION

The object of the invention is therefore to specify a simple controller of redundant design for the actuators of non-redundant design of the control valves of aircraft diesel engines, which controller guarantees reliable functioning of the engine even in the event of the occurrence of faults.

In accordance with the invention the object is achieved with an engine control system for an aircraft diesel engine for propeller-driven aircraft for purposes of controlling the injection valves, charge pressure control valves, common rail pressure control valves and propeller control valves (5 to 11) actuated by actuators of non-redundant design. The system comprises a plurality of sensors and a regulating device connected with the sensors and with the actuators, the system characterised by a first engine control unit and a second engine control unit, connected with the sensors, and in each case connected to a first power supply and a second power supply, which units are connected with one another via a serial bus and can be connected selectively to the actuators via relays that are supplied with power from the first engine control unit, wherein the two engine control units are fitted in each case with a diagnostic function for purposes of calculating the respective health level as determined by the faults registered, which units can be interchanged via the serial bus and compared with one another, and wherein in the event of the health level of the first engine control unit lying below the health level of the second engine control unit, the power supply to the relays is interrupted, and the second engine control unit is automatically connected to the actuators via the relays that have dropped out. Advantageous embodiments of the invention are discussed further below.

In an engine control system for an aircraft diesel engine for propeller-driven aircraft for purposes of controlling the injection valves, charge pressure control valves, common rail pressure control valves and propeller control valves actuated by actuators of non-redundant design, comprising a plurality of sensors and a regulating device connected with the latter and with the actuators, two—first and second—engine control units are provided, connected with the sensors and connected in each case to a first and to a second power supply, which units are connected with one another via a serial bus and can be connected selectively to the actuators via relays that are supplied with power together with the first engine control unit, wherein the two engine control units are fitted in each case with a diagnostic function for purposes of calculating their respective health levels (A and B) as determined by the faults registered, which units can be interchanged via the serial bus and are compared with one another. If the health level (A) of the first engine control unit lies below the health level (B) of the second engine control unit, the power supply to the relays is interrupted, so that the second engine control unit is automatically connected to the actuators via the relays that have dropped out, and in this manner a engine control system of redundant design for an aircraft diesel engine is present. The core of the invention lies in the connection of the two engine control units communicating with one another via relays enabling an automatic switch-over as a function of the calculated health level. If the power supply to the first engine control unit fails, or the first engine control unit is defective, the second engine control unit is automatically activated. If there is a fault at the output of one of the engine control units the other engine control unit is not affected, since neither is directly connected with the other. Moreover, in most fault modes a failure of a relay does not lead to a complete engine failure. For example, if the relay concerned fails as a result of a shorted coil the output concerned is controlled from the other engine control unit. If a relay contact has high resistance, it will be probably a contact of the first engine control unit that as a rule is active. Control can still take place via the second engine control unit.

In a further development of the invention important sensors of redundant design and less important sensors of non-redundant design are assigned to the aircraft diesel engine.

In accordance with another feature of the invention the relays are connected via a switch that can be manually activated, wherein the switch-over to the second engine control unit can be executed by the pilot by means of a manual interruption of the power supply. That is to say, by virtue of the fact that the engine control system does not detect 100% of the faults the pilot can also force a switch-over to the second engine control unit.

In an advantageous embodiment of the invention a warning lamp is connected to both engine control units for purposes of signalling a non-maximum health level (A, B). The serial bus provided for purposes of communication between the two engine control units is preferably a CAN-bus.

The diagnostics function of the first and second engine control unit includes the registration of faults and the calculation of the health level on the basis of the faults determined, wherein the faults have different weightings according to their importance for the operation of the engine. The faults that enter into the health level essentially comprise short-circuits, defective sensors, excess voltages, excess rotational speeds, too high or too low a rail pressure or charge pressure, a lack of serial communication, or similar.

### BRIEF DESCRIPTION OF THE DRAWING

An example of embodiment of an engine control system of redundant design in accordance with the invention is elucidated in more detail with the aid of the drawing, in which is represented a circuit diagram of the combination of two engine controllers with an aircraft diesel engine.

### DETAILED DESCRIPTION OF THE INVENTION

The engine control system comprises two fully digital—first and second—engine control units, of known art from aviation under the designation FADEC (Full Authority Digital Engine Control), 1 (FADEC A) and 2 (FADEC B); these are connected with one another via a connecting plate 3, and with an aircraft diesel engine 4, and in each case are connected to a power supply 21, 22. The aircraft diesel engine has four injection valves 5 to 8 and a charge pressure control valve 9, a rail pressure control valve 10, and a propeller control valve 11, which for purposes of actuation are assigned in each case to actuators 5′ to 11′ of non-redundant design. The aircraft diesel engine 4 is also fitted with a plurality of sensors 12 that are important for engine operation and therefore of redundant design (for example, rotational speed, planned performance, and similar), as well as sensors 13 that are less important and therefore of non-redundant design. The connections 12′ and 13′ of the sensors 12, 13 of redundant design and non-redundant design are connected with corresponding connections 12″, 13″ of the two engine control units 1 and 2 (FADEC A and FADEC B). In contrast, the actuators 5′ to 11′ provided for purposes of valve settings are in each case connected via a control line with a relay 14 to 20 on the connecting plate 3. The relays 14 to 20 are connected to the engine control unit 1 via a switch 23 that can be manually actuated. On the two engine control units 1 and 2 are provided in each case control valve connections 5″ to 8″ for purposes of controlling the actuators 5′ to 8′ of the injection valves 5 to 8 via the relays 14 to 17, and control valve connections 9″ to 11″ for purposes of controlling the actuators 9′ to 11′ of the charge pressure control valve 9, the rail pressure control valve 10, and the propeller control valve 11 via the relays 18, 19 and 20. In addition, each engine control unit 1 and 2 respectively has in each case two connections 21′ and 22′ to the power supplies 21 and 22 respectively, and also in each case a connection 24′, 25′ to a warning lamp 24 and 25 respectively. Finally a relay connection 23′ is also provided on the first engine control unit 1 for the connection via the switch 23 with the relays 14 to 20. In each case the injection valve connections and control valve connections 5″ to 11″ of the first engine control unit 1 (FADEC A) or the second engine control unit 2 (FADEC B) are connected via one of the relays 14 to 20 with the actuators 5′ to 11′ of the injection valves 5 to 8 or the respective control valves 9 to 11. For purposes of serial communication between the two engine control units 1 and 2 (FADEC A and FADEC B) the latter are connected with one another via a serial bus 26, here a CAN-bus, and corresponding bus connections to the respective engine control units 1 and 2. Thus two identical engine controllers are present (FADEC A and FADEC B), which can communicate with each other via the serial bus 26, and of which one is active in each case, and is connected via the relays 14-20 on the connecting plate 3 with the actuators 5′ to 11′ for the valves (5 to 11) arranged on the aircraft diesel engine 4 in order to control these valves.

The two engine control units 1 and 2 have internal diagnostic functions, which, for example, comprise the detection of short-circuits at the outputs (connections), the detection of excess voltages, defective sensors, excess rotational speeds, too high or too low a charge pressure or rail pressure, a lack of serial communication, and other faults. The diagnostic functions calculate in each case a so-called health level A and B respectively, in which the possible faults have different weightings. That is to say, for example, the failure of a less important sensor leads to a smaller drop of the respective health level than the failure of an important sensor, or the occurrence of a short circuit. The two engine control units 1 and 2 communicate with one another via the serial bus 26. The engine control unit 1 (FADEC A) also comprises a comparator, which compares the two calculated health levels A and B with one another. If both health levels are the same (A=B), or the health level of the first engine control unit 1 is greater than that of the second engine control unit 2 (A>B), the first engine control unit 1 energises the relays on the connecting plate 3 and thus has control via the actuators 5′ to 11′. If, however, the health level B of the second engine control unit 2 (FADEC B) has a higher value than health level A, the relays 14 to 20 are de-energised, so that—as represented in the drawing—the second engine control unit 2 (FADEC B) has control via the actuators 5′ to 11′. Moreover, the warning lamps 24, 25, respectively connected to each engine control unit 1 and 2, signal the non-achievement of a maximum health level A or B.

Since 100% fault detection is not possible in practice, the pilot also has the option via the switch 23, of interrupting the connection between the relays 14 to 20 and the first engine control unit 1, and thus of manually switching the relays 14 to 20 over to the second engine control unit 2. In the event of a failure of the power supply 21 to the first engine control unit 1 the relays 14 to 20 drop out and the second engine control unit 2 automatically becomes active. Also in the event of a defect of the first engine control unit 1 the second engine control unit 2 is automatically active by virtue of the non-energised relays.

### REFERENCE SYMBOL LIST

1 First engine control unit (FADEC A)

2 Second engine control unit (FADEC B)

3 Connecting plate

4 Aircraft diesel engine

5-8 Injection valves

9 Charge pressure control valve

10 Rail pressure control valve

11 Propeller control valve

5′-11′ Actuators of 5-11

5″-11″ Injection/control valve connections of 1, 2

12 Sensors of redundant design of 4

13

Sensors of non-redundant design of 4

12′, 13′ Sensor connections on 4

12″, 13″ Sensor connections on 1, 2

14-20 Relay on 3

21, 22 Power supply of 1, 2

23 Manual switch

23′ Relay connection of 1

24, 25 Warning lamp of 1, 2

26 Serial bus

26′ Bus connection on 1, 2

### TECHNICAL FIELD

The invention concerns an engine control system for an aircraft diesel engine for propeller-driven aircraft for purposes of controlling injection valves, charge pressure control valves, common rail pressure control valves and propeller control valves actuated by actuators, which system comprises a plurality of sensors and a regulating device connected to the latter and to the actuators.

### BACKGROUND

It is of known art to deploy motor vehicle diesel engines operated with an aviation fuel (kerosene) for the purpose of driving propeller-driven aircraft. Such aircraft diesel engines are operated with turbochargers to achieve a specified charge pressure and also with common rail injection, and are fitted accordingly with injection valves and also charge pressure control valves, rail pressure control valves and propeller control valves, which are actuated by actuators assigned to the valves. Control of the actuators of non-redundant design takes place by means of an engine controller on the basis of sensor signals generated by the sensors. In the event of a malfunction in the engine controller, however, reliable functioning of the diesel engine is no longer guaranteed, and in fact when it is deployed as an aircraft diesel engine the consequences are unacceptable.

### SUMMARY OF THE INVENTION

The object of the invention is therefore to specify a simple controller of redundant design for the actuators of non-redundant design of the control valves of aircraft diesel engines, which controller guarantees reliable functioning of the engine even in the event of the occurrence of faults.

1. An engine control system for an aircraft diesel engine (4) for propeller-driven aircraft for purposes of controlling the injection valves, charge pressure control valves, common rail pressure control valves and propeller control valves (5 to 11) actuated by actuators (5′ to 11′) of non-redundant design, comprising a plurality of sensors (12, 13) and a regulating device connected with the latter and with the actuators, characterised by a first and a second engine control unit (1, 2), connected with the sensors (12, 13), and in each case connected to a first and a second power supply (21, 22), which units are connected with one another via a serial bus (26) and can be connected selectively to the actuators (5′ to 11′) via relays (14 to 20) that are supplied with power from the first engine control unit (1), wherein the two engine control units (1 and 2) are fitted in each case with a diagnostic function for purposes of calculating the respective health level (A and B) as determined by the faults registered, which units can be interchanged via the serial bus (26) and are compared with one another, and wherein in the event of the health level (A) of the first engine control unit lying below the health level (B) of the second engine control unit, the power supply to the relays (14 to 20) is interrupted, and the second engine control unit (2) is automatically connected to the actuators (5′ to 11′) via the relays (14 to 20) that have dropped out.

2. The engine control system in accordance with claim 1, characterised in that important sensors (12) of redundant design and less important sensors (13) of non-redundant design are assigned to the aircraft diesel engine (4).

3. The engine control system in accordance with claim 1, characterised in that the relays (14 to 20) are connected via a switch (23) that can be manually activated, and the switch-over to the second engine control unit (2) can be executed by the pilot by means of a manual interruption of the power supply.

4. The engine control system in accordance with claim 1, characterised in that a warning lamp (24, 25) is connected to both engine control units (1, 2) for purposes of signalling a non-maximum health level (A, B).

5. The engine control system in accordance with claim 1, characterised in that the serial bus (26) is a CAN-bus.

6. The engine control system in accordance with claim 1, characterised in that the diagnostics function of the first and second engine control unit (1, 2) includes the registration of faults and the calculation of the health level on the basis of the faults determined, wherein the faults have different weightings according to their importance for the operation of the engine.

7. The engine control system in accordance with claim 6, characterised in that the faults entering into the health level essentially comprise short-circuits, defective sensors, excess voltages, excess rotational speeds, too high or too low a rail pressure or charge pressure, a lack of serial communication, or similar.
